(19) United States
(12) Patent Application Publication
(10) Pub. No.: US 2009/0076922 A1
(43) Pub. Date: Mar. 19, 2009

(54) METHOD,DEVICE AND SYSTEM FOR IMPROVING THE UTILIZATION OF CUSTOMER OPERATED TERMINALS

(76) Inventor: Rasmus de Gruil, Putten (NL)

Correspondence Address: PAUL W. MARTIN, NCR CORPORATION, LAW DEPT., 1700 S. PATTERSON BLVD., DAYTON, OH, 45479-0001, US

(21) Appl. No.: 11/857,492

(22) Filed: Sep. 19, 2007

(51) Int. Cl. G06Q 40/00

(52) U.S. Cl. 705/16

(57) ABSTRACT

Apparatuses, methods and systems used to increase the utilization of customer operated terminals. A supervisor terminal automatically gathers information on customer transactions at both customer operated and assisted checkout terminals and then continuously displays utilization information for the customer operated terminals. An operator uses the information to determine when to take certain measures to increase the utilization of the customer operated terminals.

### TECHNICAL FIELD

An apparatus, method and system described herein relates generally to improvements to the operations of customer operated terminals. More particularly, the invention relates to improvements in the performance and utilization of customer operated terminals.

### BACKGROUND

Customer operated terminals allow customers to perform many different types of transactions with little or no direct assistance from employees that may monitor or control the terminals. As a result, businesses that utilize customer operated terminals have more flexibility in scheduling employees and they are better at handling variations in customer traffic than businesses that use all employee operated terminals. Businesses having only employee operated terminals (also known as assisted terminals) must have employee operators for each terminal before the terminal can be used. This requires businesses to anticipate the level of customer traffic that will occur during the day and to coordination work schedules so as to have the proper number of employees available to operate the terminals.

The use of customer operated terminals along with operator assisted terminals reduces the burden on management to accurately anticipate customer traffic and allows more terminals to be used while requiring fewer employees to operate or monitor the terminals. However, this advantage is lost if customers do not use the customer operated terminals but instead wait in lines at operator assisted terminals. Most customer operated terminals are organized into terminal clusters with each cluster having a supervisor or monitoring terminal that allows an operator to monitor the activity of each self-checkout terminal in the cluster. From the supervisor terminal the operator can determine when a customer needs assistance and provide that help to assure that the customer has positive experience using the customer operated terminal. Additionally, the operator can take an active roll in guiding, recruiting and teaching customers to use a customer operated terminal. This increases the customer's comfort level for using the customer operated terminal and leads to higher levels of utilization for the customer operated terminals. The level of utilization for the customer operated terminals is a key component to their success. Therefore, what is needed is a way to increase the level of utilization for customer operated terminals.

### BRIEF DESCRIPTION OF THE DRAWINGS

FIG. 1 is an illustration of an embodiment of a self-checkout system.

FIG. 2 is an illustration of a supervisor terminal.

FIG. 3 is a high level flow diagram illustrating a method of operating the supervisor terminal.

### DETAILED DESCRIPTION

In the following description, numerous details are set forth to provide an understanding of the claimed invention. However, it will be understood by those skilled in the art that the claimed invention may be practiced without these details and that numerous variations or modifications from the described embodiments are possible.

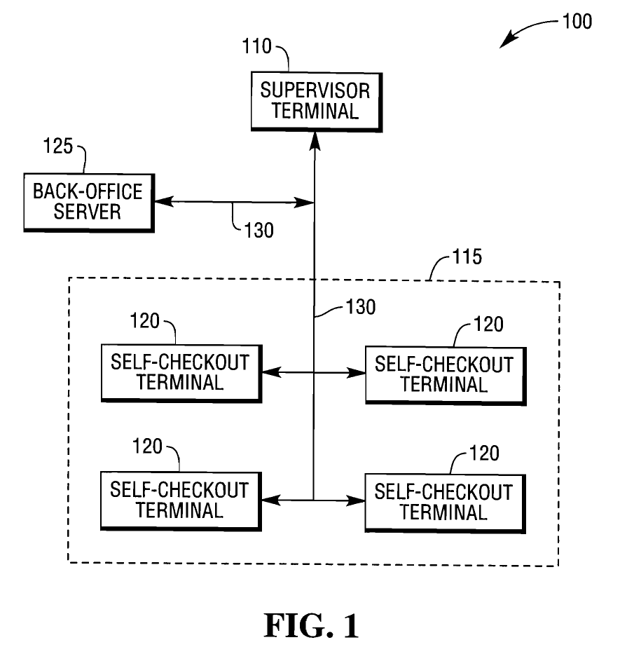

FIG. 1 provides a high-level block diagram illustrating a retail self-checkout terminal system 100, which is also one embodiment of a customer operated terminal system. In this embodiment, four self-checkout terminals 120 are grouped together to form a terminal cluster 115. Other embodiments may have terminal clusters that contains more or less than four self-checkout terminals 120. A supervisor terminal 110 is connected to each of the self-checkout terminals 120 and provides services that control and monitor of the activities of each self-checkout terminal 120. The terminal cluster 115 containing the self-checkout terminals 120 and the supervisor terminal 110 can be replicated as needed to increase the total number of self-checkout terminals 120. A back-office server 125 is connected to the supervisor terminal 110 and the self-checkout terminals 120 over a computer data network 130.

Software executed by the supervisor terminal 110 monitors and controls the activity at each self-checkout terminal 120 in the cluster 115. The self-checkout terminals 120 can function independently of the supervisor terminal 110. However, certain events can occur that require store personnel (an operator) to intervene. For example, some items for purchase have age requirements that required the checking of an ID and in other cases a security feature might require an operator's input. The operator can walk to the self-checkout terminal 120 or in most cases the events can be handled from the supervisor terminal 110, thus reducing the need to travel to the self-checkout terminal 120. In addition to supervisor functions, the supervisor terminal 110 can also perform normal assisted checkout functions if needed.

The back-office server 125 processes data and requests from each of the self-checkout terminals 120, the supervisor terminal 110 and all assisted checkout terminals (terminals that require an operator). In addition, the back-office server 125 maintains information related to the activities of all terminals connected to the network 130. The information maintained by the back-office server 125 includes a record of every transaction for each terminal and includes the type of terminal (i.e., self-checkout, assisted checkout or supervisor), items purchased, the dollar amount, time of the transaction and payment information. Using these records, software running on the back-office server 125 tracks the transactions for each terminal 120 and creates detailed statistical information which includes transactions per hour, transactions on self-checkout terminals, total transactions and other metrics.

The installation of self-checkout terminals 120 along with assisted checkout terminals will not produce a positive return on investment unless the self-checkout terminals are utilized to process at least a certain percentage of the overall customer transactions. To aid in insuring proper utilization of the self-checkout terminals 120, the back-office server 125 maintains both actual and target utilization information for the self-checkout terminals 120. Management sets the target utilization information to achieve a desired return on investment for the self-checkout terminals 120. The actual utilization information is calculated by using the total number of transactions performed at a self-checkout terminal and the total of all transactions performed at all types (self-checkout, assisted and supervisor) of checkout terminal.

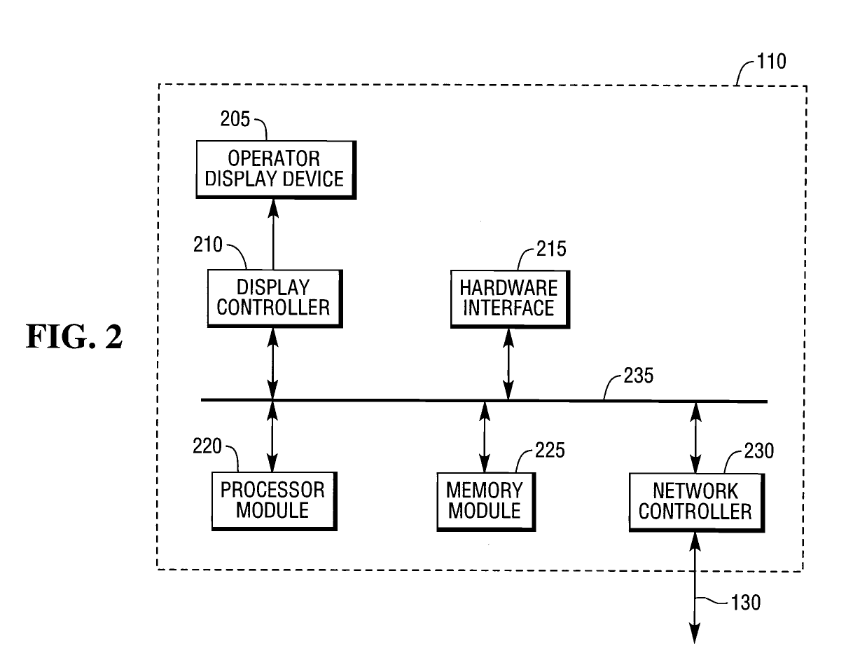

FIG. 2 is provides a high-level block diagram illustrating one embodiment of a supervisor terminal 110. The supervisor terminal 110 comprises a processor module 220, a memory module 225, a hardware interface 215, a network controller 230 and a display controller 210. The hardware interface 215 contains computer logic necessary to interface with and control peripheral components that are attached to or part of the supervisor terminal 110 (e.g., a keyboard, a USB controller, a card reader, a scanner, a payment device or a cash drawer). The network controller 230 contains the computer logic needed to implement and control the computer data network 130. The display controller 210 contains the computer logic needed to control and display information on an operator display device 205. In this embodiment, the display device 205 is an LCD display. The processor module 220 contains at least one processor and bus control logic. The bus control logic implements and controls a bus 235 which is used to communicate with the other modules and devices connected to the bus 235. The memory module 225 contains stored programs that are executed by the at least one processor to control the hardware and devices that are part of or attached to the supervisor terminal 110. The stored programs also implement the software features and functions that are part of the supervisor terminal 110. Updates to the stored programs are downloaded to the memory module 225 using numerous means including transmitting the updates over the data network 130 or using a portable memory device connected to a USB port (not shown) connected to the hardware interface 215.

An operator responsible for a terminal cluster 115 of self-checkout terminals 120 uses the supervisor terminal 110 to control and monitor the operations of each of the self-checkout terminals 120 in the cluster 115. To perform these functions, the operator must first logon to the supervisor terminal 110 using a username and password. In alternate embodiments, other means are used to identify the operator to the supervisor terminal 110 such as biometrics or smart cards. Once logged in to the supervisor terminal 110, the operator activates the self-checkout terminals 120 in the cluster 115, which means they are now ready to be used by customers to perform a customer transaction. Stored programs executing on the supervisor terminal 110 communicate with the back-office server 125 and monitor and control the self-checkout terminals 120.

The stored programs in the supervisor terminal 110 monitor and receive data about activities that occur at each of the self-checkout terminals 120. The activities can include detecting the presences of a customer, scanning an item, entering a code for an item, weighing an item, security alerts, equipment alerts and payment operations. The stored programs process the raw activity data to determine that a transaction has started and when it completes. The stored programs also maintain information on the number of transactions performed on the self-checkout terminals 120. Some of the information, which is maintained by the supervisor terminal 110, is calculated using the raw activity data retrieved directly from the self-checkout terminals 120. While other pieces of the information are retrieved from the back-office server 125 or calculated in part by using information retrieved from both the back-office server 125 and the raw activity data from the self-checkout terminals 120. Some of the information retrieved from the back-office server 125 includes the target utilization information for the self-checkout terminals and transaction information for assisted checkout terminals.

The stored programs in the supervisor terminal 110 continuously display all or a portion of the maintained information on the operator display device 205 as long as the operator is logged-on to the supervisor terminal 110. In some embodiments, store management can select what portion of the maintained information is displayed on the operator display device 205 and they can force the information to be displayed even when an operator is not logged on to the supervisor terminal 110. Operators cannot change selections made by management and the information being continuously displayed is not the result of commands entered by the operator to display information. The information is displayed in an area of the screen that is separate from all other functions that are implemented by the supervisor terminal. The information is present on the screen no matter what other functions are being performed.

The maintained information displayed on the operator display device 205 includes statistical information related to self-checkout transactions and the utilization of the self-checkout terminals. This information includes the actual percentage of total self-checkout transactions to all transactions, the target percentage for all self-checkout transactions and the deviation between the actual and target percentages. Other statistical information related to self-checkout transactions can also be displayed such as the actually number of transactions.

Continuously displaying at least the deviation between the actual and target number of self-checkout transactions provides the operator with real-time feedback on how well the self-checkout terminals 120 are being utilized and allows the operator to adjust their time and actions as needed to increase the number of transactions that occur at the self-checkout terminals 120 versus assisted checkout terminals. These actions include announcing to customers standing in line at assisted checkout terminals that there are one or more self-checkout terminals 120 that are open for immediate checkout. The operator may further offer to assist the customer if they have any questions or if they do not have much experience using a self-checkout terminal 120. These types of actions have been shown to increase the utilization of self-checkout terminals 120. Furthermore, these actions increase customer satisfaction by reducing the wait time to checkout and by reducing the fear or confusion a customer may have when learning how to operate a self-checkout terminal. Providing continuously feedback to the operator (without input from the operator) in the form of self-checkout utilization information displayed on the operator display device 205 provides the necessary motivation for the operator to improve the utilization of the self-checkout terminals 120.

In some embodiments, the stored programs on the supervisor terminal 110 will continuously display some or all the transaction information even when no operator is logged-on to the terminal. The information can be displayed as part of a screen saver for the operator display device 205 or just as data that is displayed on the device along with login instructions. In either case, the information is continuously displayed and updated periodically.

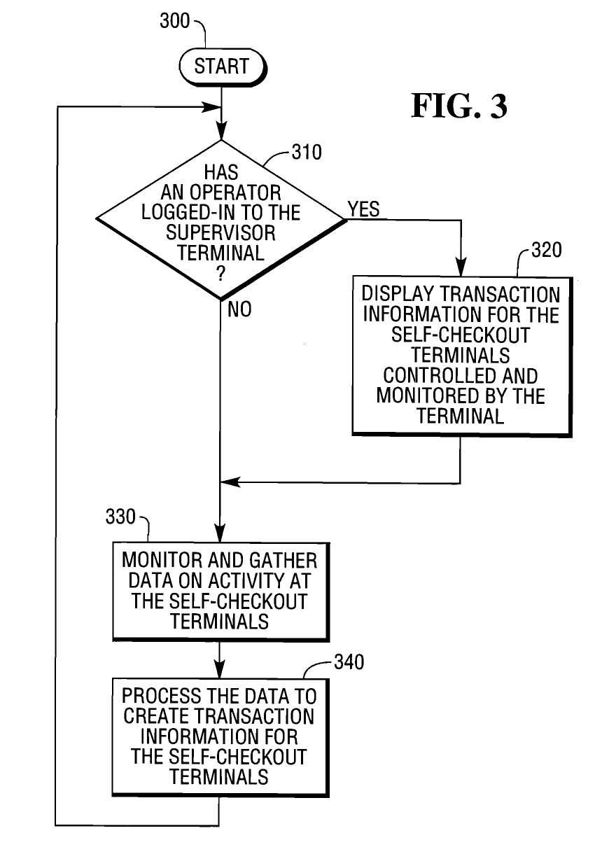

Now turning to FIG. 3, there is presented a high level flow diagram of one embodiment of stored software executing on the supervisor terminal 110. This flow diagram starts at step 300 where control is transferred to a decision block 310 to determine if a self-checkout operator is logged-on to the supervisor terminal 110. If an operator is logged on, control is passed to step 320 where transaction information for the self-checkout terminals control by the supervisor's terminal is displayed. If no operator is logged on to the supervisor's terminal, control is passed to step 330 where the supervisor terminal continues to monitor and gather data on the activities being performed by the self-checkout terminals 120. In step 340, the data that is gathered is statistically processed to create transaction information, which contains details about the transactions being performed by the self-checkout terminals 120. After step 340, control passes back to step 310.

It should be noted that other than the act of an operator logging onto the supervisor terminal 110, no further action is required by the operator for the supervisor terminal 110 to display the transaction information. In fact, the operator cannot stop or change the information being displayed. Only store management can change the display of the transaction information. In this embodiment, the software will stop displaying the transaction information when the operator logs off the supervisor's terminal 110 (by issuing a logoff command).

In other embodiments, the software will continue to display transaction information even when no operator is logged-on to the supervisor terminal 110. The displaying of transaction information will occur automatically without an operator being logged into the supervisor terminal 110. This allows operators that may pass by the supervisor terminal to see the transaction utilization information with out having to stop and logon to the supervisor terminal 110. If the information indicates a low utilization, the operator may decide to recruit customers to use the self-checkout terminals in order to increase utilization of the self-checkout terminals.

While the invention is disclosed in the context of a retail self-checkout embodiment, it will be recognized that a wide variety of implementations involving customer operated terminals may be employed by a person of ordinary skill in the art consistent with the above discussion and the claims, which follow below. In addition to the retail self-checkout implementation, other implementations include but are not limited to customer operated terminals used by retail music stores, hotels, restaurants, the U.S. Post Office, package carries, medical facilities, rental companies, airlines and transportation related industries. The customer operated terminals perform many different kinds of transaction such as previewing music, entering orders, weighing packages, check-in customers and renting cars or other equipment and can all benefit from the present invention.

What is claimed is:

1. A computer implemented method for use in a supervisor terminal that monitors one or more customer operated terminals and that provides transaction information used to increase the utilization of the one or more customer operated terminals, the method comprising:
receiving activity data for each of the one or more customer operated terminals;
processing the activity data to create the transaction information for the one or more customer operated terminals; and
continuously displaying on the supervisor terminal at least a part of the transaction information.

2. The method of claim 1, wherein the transaction information includes the total number of transactions for the one or more customer operated terminals.

3. The method of claim 1, further comprising receiving additional transaction information from a back-office server.

4. The method of claim 3, wherein the received additional transaction information includes target transaction information for the one or more customer operated terminals.

5. The method of claim 4, wherein the supervisor terminal continuously displays information comparing customer transactions performed on the one or more customer operated terminals with the target transaction information for the one or more customer operated terminals.

6. The method of claim 1, wherein the continuous displaying of transaction information begins after a logon command is successfully processed by the supervisor terminal and prior to receiving any additional commands.

7. The method of claim 6, wherein the continuous displaying of transaction information stops when a logoff command is successfully processed by the supervisor terminal.

8. The method of claim 1, wherein the supervisor terminal continuously displays transaction information without receiving a command from an operator to display the transaction information.

9. The method of claim 1, wherein the customer operated terminal is a retail self-checkout terminal.

10. The method of claim 1, wherein the customer operated terminal is a customer self check-in terminal.

11. A supervisor terminal that controls and monitors a plurality of customer operated terminals and provides transaction information used to increase the utilization of the plurality of customer operated terminals, the supervisor terminal comprising:
a memory comprising one or more stored programs;
a processor adapted to execute the one or more stored programs which causes the supervisor terminal to:
a) receive activity information from each of the plurality of customer operated terminals;
b) process the activity information for each of the plurality of customer operated terminals to create the transaction information for the plurality of customer operated terminals; and
c) continuously displaying on the supervisor terminal at least a part of the transaction information.

12. The supervisor terminal of claim 11, where the transaction information includes the total number of transactions for the plurality of customer operated terminals.

13. The supervisor terminal of claim 11, where the processor is further adapted to receive additional transaction information from a back-office server.

14. The supervisor terminal of claim 13, where the received additional transaction information includes target transaction information for plurality of customer operated terminals.

15. The supervisor terminal of claim 14, where the processor continuously displays information comparing customer transactions performed on the one or more customer operated terminals with the target transaction information for the plurality of customer operated terminals.

16. The supervisor terminal of claim 15, where the continuous displaying of transaction information begins after a logon command is successfully processed and prior to receiving any additional commands.

17. The supervisor terminal of claim 16, where the continuous displaying of transaction information stops when a logoff command is successfully processed.

18. The supervisor terminal of claim 11, where the processor continuously displays transaction information without receiving a command from an operator to display the transaction information.

19. The supervisor terminal of claim 11, where the plurality of customer operated terminals are retail self-checkout terminals.

20. The supervisor terminal of claim 11, where the plurality of customer operated terminals are customer self check-in terminals.

21. A customer operated terminal system that provides transaction information used to increase the utilization of the system, the system comprising:
a plurality of customer operated terminals; and
a supervisor terminal in communications with the plurality of customer operated terminals and adapted to:
a) receive activity information from each of the plurality of customer operated terminals;
b) process the activity information for each of the plurality of customer operated terminals to create the transaction information for the plurality of customer operated terminals; and
c) continuously displaying on the supervisor terminal at least a part of the transaction information.

22. The system of claim 21, where the transaction information includes the total number of transactions for the plurality of customer operated terminals.

23. The system of claim 21, where the supervisor terminal is further adapted to receive additional transaction information from a back-office server.

24. The system of claim 23, where the received additional transaction information includes target transaction information for plurality of customer operated terminals.

25. The system of claim 24, where the supervisor terminal continuously displays information comparing customer transactions performed on the one or more customer operated terminals with the target transaction information for the plurality of customer operated terminals.

26. The system of claim 25, where the continuous displaying of transaction information begins after a logon command is successfully processed and prior to receiving any additional commands.

27. The system of claim 26, where the continuous displaying of transaction information stops when a logoff command is successfully processed.

28. The system of claim 21, where the supervisor terminal continuously displays transaction information without receiving a command from an operator to display the transaction information.

29. The system of claim 21, where the plurality of customer operated terminals are retail self-checkout terminals.

30. The system of claim 21, where the plurality of customer operated terminals are customer self check-in terminals.
